(19) United States
(12) Patent Application Publication
(10) Pub. No.: US 2026/0356747 A1
(43) Pub. Date: Nov. 12, 2026

(54) METHOD FOR PROCESSING DUST CONTAINING ORGANIC RESIDUES IN A CEMENT MANUFACTURING PLANT

(71) Applicant: AMRIZE TECHNOLOGY SWITZERLAND LLC, ZUG (CH)

(72) Inventor: Beat CABERNARD, UNTERVAZ (CH)

(21) Appl. No.: 19/129,973

(22) PCT Filed: Nov. 9, 2023
(86) PCT No.: PCT/IB2023/061332

§ 371 Date: May 14, 2025

(30) Foreign Application Priority Data
Nov. 15, 2022 (EP) 22020557.9

(51) Int. Cl. C04B 7/36; C04B 18/162

(52) U.S. Cl. CPC C04B 7/364; C04B 18/162

(57) ABSTRACT

In a method for processing dust containing organic residues in a cement manufacturing plant, the dust is introduced into the chlorine bypass of the cement manufacturing plant, the introduced dust is contacted with kiln exhaust gas loaded with kiln dust and introduced into the chlorine bypass from a rotary kiln of the cement manufacturing plant, and the organic residues are burned in a reaction zone of the chlorine bypass at a temperature of >580 °C, whereupon the dust is cooled downstream of the reaction zone and separated from the kiln exhaust gas and discharged from the chlorine bypass.

The invention relates to a method for processing dust containing organic residues in a cement manufacturing plant.

In order to reduce the use of fossil fuels in cement production, alternative fuels such as dried sewage sludge, industrial waste or non-recyclable plastics are being used increasingly. If large quantities of alternative fuels are used in a cement plant, organic residues and heavy metals may accumulate in the cement production plant as an indirect consequence. The natural and alternative raw materials for clinker production can also contribute to organic residues and pollutants.

These organic residues usually accumulate in the cement kiln dust and lead to the fact that, unlike usual, the cement kiln dust cannot be added to the cement mill without further ado after its separation from the exhaust gas stream, because the unburned organic residues in the cement represent unwanted impurities. For example, organic residues in the cement lead to dark spots in the final product made of concrete, which is disadvantageous for aesthetic reasons. Furthermore, organic residues have a negative effect on the control of air-entraining agents in concrete compositions and on the rheology of concrete compositions before setting.

The accumulation of heavy metals in the kiln exhaust gas leads to contamination of the environment if no suitable measures are taken to separate the heavy metals. A particularly problematic heavy metal is, for example, mercury, which is present in the kiln exhaust gas in the gaseous state.

The present invention therefore aims to enable the use of alternative fuels and organically contaminated raw materials for the production of cement clinker without having to accept the disadvantages described above.

To achieve this object, the invention provides a method for processing dust containing organic residues in a cement manufacturing plant, comprising the introduction of the dust into the chlorine bypass of the cement manufacturing plant, contacting the introduced dust with kiln exhaust gas loaded with kiln dust and introduced into the chlorine bypass from a rotary kiln of the cement manufacturing plant, and burning the organic residues in a reaction zone of the chlorine bypass at a temperature of >580 °C, whereupon the dust is cooled downstream of the reaction zone and separated from the kiln exhaust gas and discharged from the chlorine bypass.

The invention is thus based on the idea of using the thermal energy present in the chlorine bypass to eliminate the organic residues of the dust by combustion. The chlorine bypass is understood to be a partial gas extraction of the kiln exhaust gas of a rotary kiln of a cement manufacturing plant in the area of the kiln inlet to limit chlorine, alkali and sulphur circuits. In numerous cement manufacturing plant, such a chlorine bypass is installed between the rotary kiln and the preheater in order to subject a partial flow of the kiln gas to a separate treatment. This reduces the chlorine content in the area of the kiln inlet, which results in less enrichment of this element and less caking and clogging.

The kiln exhaust gas branched off at the kiln inlet and entering the chlorine bypass has a temperature of approximately 1,000 to 1,100 °C and leads to combustion of the organic residues upon contact with the dust loaded with the organic residues introduced into the chlorine bypass. The reaction zone of the chlorine bypass, into which the dust is introduced and in which the combustion takes place, is arranged as close as possible to the kiln inlet, the temperature in the reaction zone being >580 °C, preferably >650 °C.

The organic residue-containing dust to be processed according to the invention is not the kiln dust that passes directly into the chlorine bypass together with the kiln exhaust gas from the rotary kiln. Rather, the dust to be processed according to the invention is a dust that is introduced into the chlorine bypass from the outside and, for example, is introduced into the chlorine bypass from a dust silo. For the introduction of the dust, for example, a feed pipe is provided, which opens into the chlorine bypass transversely, in particular perpendicularly or obliquely, to the pipe axis of the chlorine bypass.

The dust loaded with organic residues is preferably introduced, in particular injected, into a riser of the chlorine bypass connected to the kiln inlet.

In order to ensure as complete a combustion of the organic residues as possible, a minimum residence time of the dust in the hot reaction zone of the chlorine bypass is to be strived for. A preferred embodiment of the method according to the invention therefore provides for the dust to be kept in the chlorine bypass, in particular in the reaction zone, for a period of time that causes complete combustion of the organic residues. The residence time of the dust in the reaction zone comprising a temperature of >580 °C is preferentially at least 1 second, preferably at least 2 seconds.

However, it is not mandatory that the complete combustion of the organic residues takes place in the reaction zone itself. It is also possible for the combustion process of the organic residues to continue after a residence time of >1 second, preferably >2 seconds, at a temperature of >580 °C, preferably >650 °C, downstream of the reaction zone.

In order to ensure a sufficient residence time of the dust in the reaction zone, it is preferably provided that a flow rotating about a pipe axis of the chlorine bypass is generated and/or maintained in the reaction zone.

Preferably, a carrier gas, preferably air, is introduced into the chlorine bypass with an angular momentum in order to generate the rotating flow. This is achieved, for example, by tangentially blowing the carrier gas into the chlorine bypass. The carrier gas introduced at ambient temperature, for example, forms a cold protective layer for the pipe wall on the pipe wall of the chlorine bypass, which surrounds the dust and imparts a movement component to the dust in the direction of rotation. The carrier gas thereby reduces the contact of the dust with the pipe wall and cools the pipe wall, thereby reducing sticking of the pipe wall due to deposits of components such as sulphur and chlorine.

After burning out the organic impurities, the dust is cooled and separated from the kiln exhaust gas and discharged from the chlorine bypass. In this case, the dust is preferably cooled by blowing in air, for example in a quench chamber, as is done in a conventional manner in the case of a chlorine bypass.

The cooling is preferably carried out in two stages, the dust being subjected to a first cooling to a temperature of 580-680 °C, the partially cooled dust being fed to a separation device in which a coarse fraction of the dust is separated and discharged and optionally introduced into the rotary kiln, and the dust being subjected to a second cooling to a temperature of <140 °C, at which heavy metals contained in the kiln exhaust gas condense and are deposited on a fine fraction of the dust. The first and/or the second cooling preferably takes place by blowing in air, in particular ambient air.

Due to the fact that the partially cooled dust is fed to a separation device, in particular a cyclone separator, in which a coarse fraction of the dust is separated and discharged and fed into or returned to the rotary kiln, the amount of dust produced by the cement manufacturing plant can be further reduced.

In principle, dusts containing organic residues of any origin can be treated with the method according to the invention. In particular, these are dusts that contain both organic residues and heavy metals, such as As, Pb, Cd, Cr, Co, Ni, Tl, Zn and Hg.

Particular preference is given to treating dust that originates from the cement manufacturing plant itself, namely cement kiln dust that has been separated from the kiln exhaust gas after the kiln exhaust gas has passed through a raw meal preheater and then has been cooled.

Since the process according to the invention ensures that the dust treated in the chlorine bypass and separated from it no longer contains any organic impurities, it can easily be added to a cement clinker and ground with it in a cement mill.

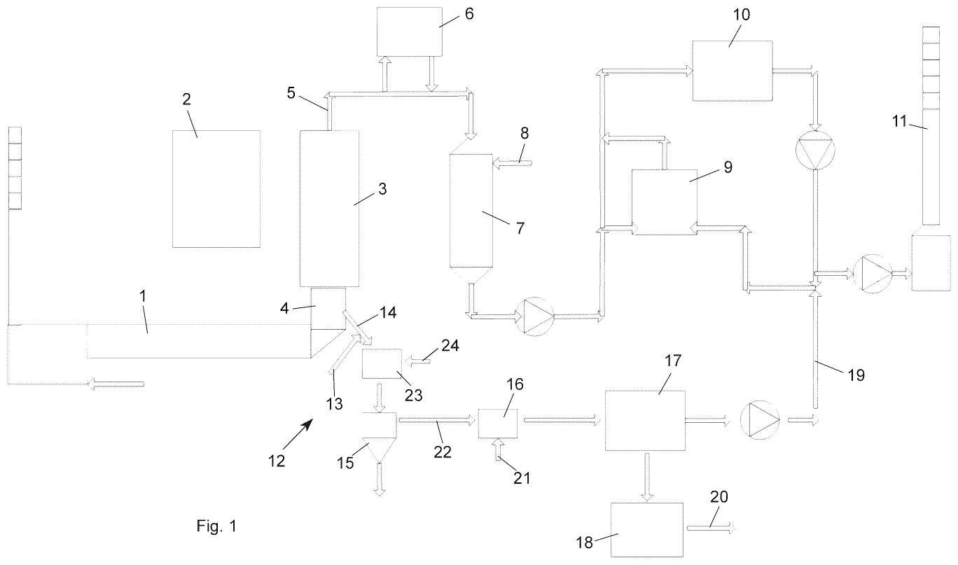

The invention is explained in more detail below with reference to an exemplary embodiment schematically illustrated in the drawing. In the drawing FIG. 1 shows a layout of a cement manufacturing plant, which is designed for carrying out the method according to the invention.

The cement manufacturing plant comprises a rotary kiln 1 in which preheated and possibly pre-calcined raw meal is calcined to form cement clinker. The raw meal is stored in a silo 2 and fed to a raw meal preheater 3, in which the raw meal is passed through a plurality of cyclone or vortex chamber stages arranged one behind the other in inverse flow to the hot exhaust gas coming from rotary kiln 1. The preheated raw meal enters the rotary kiln 1 via the kiln inlet 4, while the exhaust gas is discharged from the raw meal preheater 3 via the pipe 5. The heat of the exhaust gas can be utilized in a waste heat recovering device 6, whereupon the exhaust gas is quenched in a conditioning tower 7 with the addition of water 8. The residual heat of the exhaust gas can be used in a raw meal mill and/or a raw meal preheater 9 to preheat the raw meal. The dust fractions contained in the exhaust gas, comprising cement kiln dust and raw meal dust, are separated in the main filter 10, so that the exhaust gas freed of dust can be discharged via the chimney 11.

The dust containing organic residues 13 separated in the main filter 10 is now fed according to the invention to the chlorine bypass 12 of the cement kiln plant. The chlorine bypass 12 is connected to the kiln inlet 4 and serves to withdraw a portion of the kiln exhaust gas from the rotary kiln 1 to limit chlorine, alkali and sulfur circuits. In the reaction zone 14 of the chlorine bypass 12, the organic constituents of the charged dust 13 are at least partially burnt at a suitable temperature. Further burnout may also occur in a more downstream region 22 of the chlorine bypass. In between, a cooling chamber 23 and an optional separation cyclone 15 are arranged, via which coarse components of the dust can be separated and returned to the rotary kiln 1. Subsequently, the exhaust gas is cooled in an additional quench chamber 16 by adding air 21 and the dust is separated in a filter 17. The dust is stored in a silo 18, wherein the cleaned exhaust gas is supplied to the chimney 11 via the pipe 19. The dust 20 can subsequently be added as an additive to cement in a cement mill.

1. A method for processing dust containing organic residues in a cement manufacturing plant, comprising introducing the dust into the chlorine bypass of the cement manufacturing plant, contacting the introduced dust with kiln exhaust gas loaded with kiln dust and introduced into the chlorine bypass from a rotary kiln of the cement manufacturing plant, and burning the organic residues in a reaction zone of the chlorine bypass at a temperature of >580 °C, whereupon the dust is cooled downstream of the reaction zone and separated from the kiln exhaust gas and discharged from the chlorine bypass.

2. The method according to claim 1, wherein the dust is kept in the chlorine bypass, for a period of time that causes complete combustion of the organic residues.

3. The method according to claim 1, wherein a flow rotating about a pipe axis of the chlorine bypass is generated and/or maintained in the reaction zone

4. The method according to claim 3, wherein a carrier gas is introduced into the chlorine bypass with an angular momentum to generate the rotating flow.

5. The method according to claim 1, wherein the cooling of the dust is carried out by blowing in air.

6. The method according to claim 1, wherein the dust is subjected to a first cooling to a temperature of 580-680 °C, the partially cooled dust is fed to a separation device in which a coarse fraction of the dust is separated and discharged and optionally introduced into the rotary kiln, and wherein the dust is subjected to a second cooling to a temperature of <140 °C, at which heavy metals contained in the kiln exhaust gas condense and are deposited on a fine fraction of the dust.

7. The method according to claim 1, wherein the dust is separated from the kiln exhaust gas, which has passed through a raw meal preheater and has then been cooled, and is introduced into the chlorine bypass

8. The method according to claim 1, wherein the dust discharged from the chlorine bypass is added to a cement clinker and ground therewith in a cement mill.

9. The method according to claim 2, wherein the dust is kept in the reaction zone for said period of time that causes complete combustion of the organic residues.

10. The method according to claim 4, wherein the carrier gas is air.
